(19) United States
(12) Patent Application Publication
(10) Pub. No.: US 2026/0241213 A1
(43) Pub. Date: Aug. 20, 2026

(54) BATTERY SELF-EXTINGUISHING DEVICE AND BATTERY MODULE SELF-EXTINGUISHING DEVICE

(71) Applicant: Samsung SDI Co., Ltd., Yongin-si (KR)

(72) Inventor: Hyunwoo Kim, Yongin-si (KR)

(73) Assignee: Samsung SDI Co., Ltd., Yongin-si (KR)

(21) Appl. No.: 19/538,162

(22) Filed: Feb. 12, 2026

(30) Foreign Application Priority Data
Feb. 20, 2025 (KR) 10-2025-0022495

(51) Int. Cl. A62C 3/16; H01M 10/613; H01M 10/6561

(52) U.S. Cl. CPC A62C 3/16; H01M 10/613; H01M 10/6561; H01M 2200/10; H01M 2200/20

(57) ABSTRACT

A battery self-extinguishing device includes a plate deformed when pressure and/or a temperature within a battery cell rises, a moving tab connected to the plate and moved in response to the deformation of the plate, a side tab connected to the moving tab and having a wrinkle structure and having a wrinkle unfolded in response to the movement of the moving tab, and a case connected to the side tab and formed to have an internal space extended as the wrinkle of the side tab is unfolded so that a temperature of the battery cell is lowered by adiabatic expansion.

### CROSS-REFERENCE TO RELATED APPLICATIONS

This present application claims priority to and the benefit under 35 U.S.C. 119(a)-(d) of Korean Patent Application No. 10-2025-0022495, filed on Feb. 20, 2025, in the Korean Intellectual Property Office, the entire disclosure of which is incorporated herein by reference.

### FIELD

The present disclosure relates to a battery device capable of self-extinguishing a fire which may occur within a battery based on the principle of adiabatic expansion.

### BACKGROUND

Unlike primary batteries, which cannot be recharged, secondary batteries are batteries that can be charged and discharged. Low-capacity secondary batteries are used in portable small electronic devices such as smartphones, feature phones, notebook computers, digital cameras, and camcorders, while high-capacity secondary batteries are widely used as power sources for motor drive in hybrid vehicles and electric vehicles, as well as for energy storage applications. Such secondary batteries include an electrode assembly composed of a positive electrode and a negative electrode, a case accommodating the electrode assembly, and electrode terminals connected to the electrode assembly.

As described herein, the secondary battery plays an important role in various electronic devices and vehicle industries due to the characteristic in which the secondary battery can be charged. However, while the secondary battery is used, a safety problem occurs frequently due to an increase of a temperature and pressure within the battery.

Particularly, if a chemical reaction within the battery excessively occurs due to overcharge, a short circuit, or an external impact, thermal run away may occur, which may lead to overheating, a fire, or explosion of the battery.

The existing battery extinguishing device basically uses a method of responding to a fire after the fire occurs by using an external extinguisher or system.

However, such a method has limitations in rapidly controlling a fire. There emerges a need for a self-extinguishing technique in which a battery can autonomously suppress a fire at the early stage of the fire.

### SUMMARY

A battery self-extinguishing device according to embodiments of the present disclosure may include a plate deformed when pressure and/or a temperature within a battery cell rises, a moving tab connected to the plate and moved in response to the deformation of the plate, a side tab connected to the moving tab and having a wrinkle structure and having a wrinkle unfolded in response to the movement of the moving tab, and a case connected to the side tab and formed to have an internal space extended as the wrinkle of the side tab is unfolded so that a temperature of the battery cell is lowered by adiabatic expansion.

A battery self-extinguishing device according to embodiments of the present disclosure may include a substantially dome-shaped plate configured to block an electrical connection with an electrode tab by being deformed when pressure and/or a temperature within a battery cell rises, a moving tab connected to the substantially dome-shaped plate and moved in response to the deformation of the substantially dome-shaped plate, a side tab connected to the moving tab and having a wrinkle structure and having a wrinkle unfolded in response to the movement of the moving tab, and a case connected to the side tab and formed to have an internal space extended in response to the unfolding of the wrinkle of the side tab so that a temperature of the battery cell is lowered by adiabatic expansion.

### BRIEF DESCRIPTION OF THE DRAWINGS

The following drawings illustrate example embodiments of the present disclosure, and further describe example aspects of the present disclosure together with the detailed description of the present disclosure. Thus, the present disclosure should not be construed as being limited to the drawings:

FIG. 1 schematically illustrates a configuration of a pouch-type secondary battery;

FIG. 2 is a cross-sectional view of a cylindrical secondary battery.

FIG. 3A illustrates a schematic external appearance configuration of a prismatic secondary battery.

FIG. 3B is a cross-sectional view taken along line I-I′ of FIG. 3A.

FIG. 4 is an example view of a secondary battery module in which secondary batteries manufactured according to examples of the present disclosure are arranged.

FIG. 5 is an example view of a secondary battery pack including the secondary battery module illustrated in FIG. 4.

FIG. 6 is a conceptual view of a vehicle including the secondary battery pack illustrated in FIG. 5.

FIG. 7 is a schematic diagram illustrating an adiabatic expansion process of a battery cell case in a battery self-extinguishing device according to embodiments of the present disclosure.

FIG. 8 is a schematic diagram illustrating an adiabatic expansion process of a battery module case in a battery self-extinguishing device according to embodiments of the present disclosure.

FIG. 9 illustrates a process of a plate being deformed in a battery self-extinguishing device according to embodiments of the present disclosure.

### DETAILED DESCRIPTION

The example embodiments described in this specification and the configurations shown in the drawings are only some example embodiments of the present disclosure and do not represent all of the aspects of the present disclosure. Accordingly, it should be understood that there may be various equivalents and modifications that can replace or modify one or more example embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more £ features, integers, steps, operations, elements, components, and/or groups thereof.

The terms used in the present specification are intended to describe embodiments of the present disclosure and are not intended to limit the present disclosure.

Embodiments of the present disclosure are directed to providing a battery self-extinguishing device which suppresses or extinguishes a fire within a battery based on the principle of adiabatic expansion.

According to embodiments of the present disclosure, it is possible to prevent a fire and maintain the stability of a battery by automatically responding to an increase in the temperature and pressure within the battery cell or module. A space within the battery cell is extended through an interlocking action of the plate, the moving tab, and the side tab. Accordingly, it is possible to reduce the possibility of a fire because a temperature within the battery cell or module is lowered by adiabatic expansion.

According to embodiments of the present disclosure, the battery self-extinguishing device detects a change within the battery cell or module and automatically operates even without the supply of external power, resulting in a cost reduction and ease of installation.

The effects of the present disclosure are not limited to those described herein, and other effects not mentioned herein will be clearly understood by those skilled in the art from the description set forth herein.

However, the technical problems to be solved by the present disclosure are not limited to the herein-described problems, and other problems not mentioned herein will be clearly understood by those skilled in the art from the description of the disclosure set forth herein.

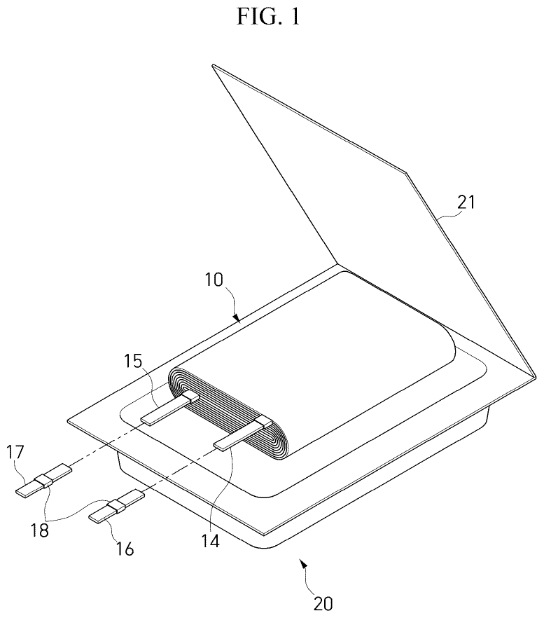

FIG. 1 Schematically Illustrates a Pouch-type secondary battery.

The pouch-type secondary battery may be composed of an electrode assembly (10) and a pouch (20) accommodating the electrode assembly (10).

As shown in FIG. 1, a first electrode tab (14) and a second electrode tab (15) of the electrode assembly (10) may be welded to and electrically connected with an external first terminal lead (16) and a second terminal lead (17), respectively. A tab film (18) for insulation from the pouch (20) may be attached to the first terminal lead (16) and the second terminal lead (17).

With the electrode assembly (10) accommodated therein, the pouch (20) may be sealed by bringing sealing portions (21) at the edges thereof into contact with each other, and in this process, sealing may be performed with the tab film (18) interposed between the sealing portions (21). The sealing portions (21) of the pouch (20) are formed of a heat-fusible material, and since the heat fusible material generally has poor adhesion to metal, the pouch (20) may be fused by interposing the tab film (18) in the form of a thin film.

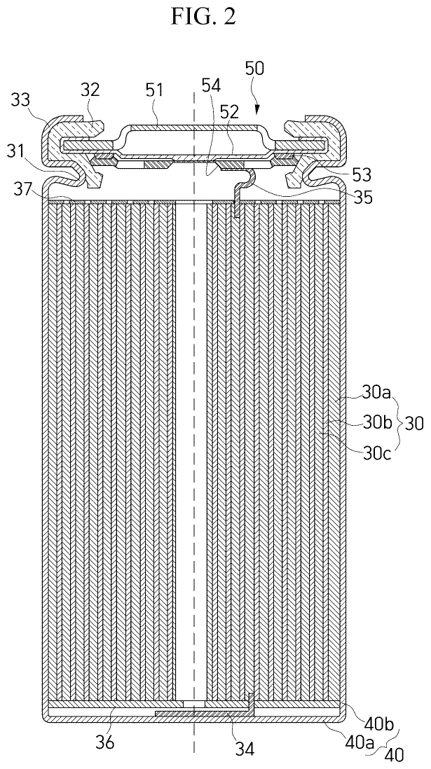

FIG. 2 is a cross-sectional view of a cylindrical secondary battery. The cylindrical secondary battery includes an electrode assembly (30), a case (40) that accommodates the electrode assembly (30) and an electrolyte therein, a cap assembly (50) coupled to an opening of the case (40) to seal the case (40), and an insulating plate (37) positioned inside the case (40) between the electrode assembly (30) and the cap assembly (50).

The electrode assembly (30) may include a separator (30b), and a first electrode (30c) and a second electrode (30a) disposed with the separator (30b) interposed therebetween, and may be wound in a jelly-roll form.

The first electrode (30c) includes a first substrate and a first active material layer disposed on the first substrate. A first lead tab (35) may extend outward from a first uncoated portion of the first substrate on which the first active material layer is not disposed, and the first lead tab (35) may be electrically connected to the cap assembly (50).

The second electrode (30a) includes a second substrate and a second active material layer disposed on the second substrate. A second lead tab (34) may extend outward from a second uncoated portion of the second substrate on which the second active material layer is not disposed, and the second lead tab (34) may be electrically connected to the case (10). The first lead tab (35) and the second lead tab (34) may extend in opposite directions.

The first electrode (30c) may function as a positive electrode. In this case, the first substrate may be made of, for example, aluminum foil, and the first active material layer may include, for example, a transition metal oxide. The second electrode (30a) may function as a negative electrode. In this case, the second substrate may be made of, for example, copper foil or nickel foil, and the second active material layer may include, for example, graphite.

The separator (30b) functions to prevent a short circuit between the first electrode (30c) and the second electrode (30a) while allowing the movement of lithium ions. The separator (32) may be made of, for example, a polyethylene film, a polypropylene film, or a polyethylene-polypropylene film.

The case (40) accommodates the electrode assembly (30) and the electrolyte, and together with the cap assembly (50), forms the outer shape of the battery. The case (40) may include a substantially cylindrical body portion (40b) and a bottom portion (40a) connected to one side of the body portion (40b). A beading portion (31) deformed inward may be provided in the body portion (40b), and a crimping portion (33) bent inward may be provided at an end of the opening side of the body portion (40b).

The beading portion (31) may suppress movement of the electrode assembly (30) within the case (40) and facilitate seating of the gasket (32) and the cap assembly (50). The crimping portion (33) may firmly fix the cap assembly (50) by pressing an edge of the cap assembly (50) through the gasket (32). The case (40) may be made of, for example, nickel-plated iron.

The cap assembly (50) may be fixed to an inner side of the crimping portion (33) via the gasket (32) to seal the case (40). The cap assembly (50) may include a cap-up (51), a safety vent (52), a cap-down (53), an insulating member, and a sub-plate (54), but is not limited thereto and may be variously modified.

The cap-up (51) may be positioned at an uppermost portion of the cap assembly (50). The cap-up (51) may protrude upwardly to include a terminal portion for connection to an external circuit, and an outlet for discharging gas may be provided around the terminal portion.

The safety vent (52) may be positioned below the cap-up (51). The safety vent (52) may protrude downwardly and include a protrusion connected to the sub-plate (54) and at least one notch disposed around the protrusion.

When gas is generated due to overcharging or abnormal operation of the secondary battery, the protrusion may be deformed upwardly by pressure and separated from the sub-plate (54), and the safety vent (52) may be cut along the notch. The cut safety vent (52) may discharge gas to the outside to prevent explosion of the secondary battery.

The cap-down (53) may be positioned below the safety vent (52). The cap-down (53) may include a first opening for exposing the protrusion of the safety vent (52) and a second opening for gas discharge. An insulating member may be disposed between the safety vent (52) and the cap-down (53) to insulate the safety vent (52) from the cap-down (53).

The sub-plate (54) may be positioned below the cap-down (53). The sub-plate (54) may be fixed to a lower surface of the cap-down (53) to block the first opening of the cap-down (53), and the protrusion of the safety vent (52) may be fixed to the sub-plate (54). The first lead tab (35) drawn out from the electrode assembly (30) may be fixed to the sub-plate (54). Accordingly, the cap-up (51), the safety vent (52), the cap-down (53), and the sub-plate (54) may be electrically connected to the first electrode (30c) of the electrode assembly (30).

The insulating plate (37) may be positioned to contact the electrode assembly (30) below the beading portion (13), and a tab opening for drawing out the first lead tab (35) may be provided in the insulating plate (37). The cap assembly (50) electrically connected to the first electrode (30c) by the first lead tab (35) may face the electrode assembly (30) with the insulating plate (37) interposed therebetween, and the electrode assembly (30) may be maintained in an insulated state by the insulating plate (37). Meanwhile, another insulating plate (36) for insulation between the electrode assembly (30) and the bottom portion (40a) of the case (40) may be included.

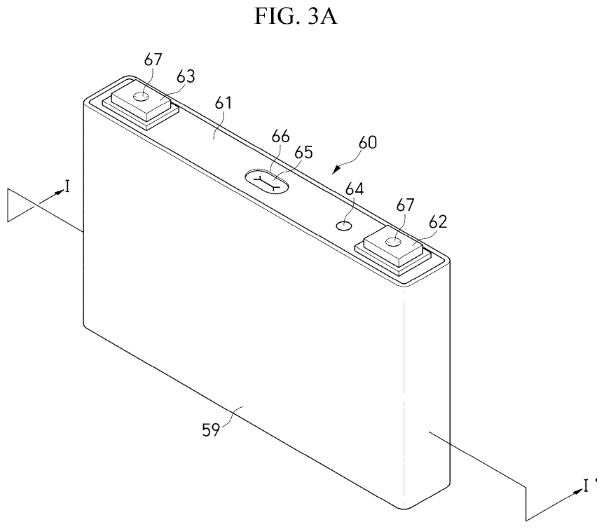

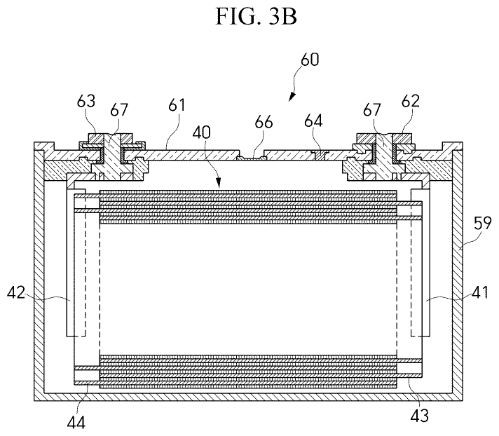

FIG. 3A is a top perspective view illustrating the external appearance of a prismatic secondary battery.

The case (59) forms the overall external appearance of the prismatic secondary battery and may be formed of a conductive metal such as aluminum, an aluminum alloy, or nickel-plated steel. In addition, the case (59) may provide a space in which an electrode assembly is accommodated.

The cap assembly (60) may include a cap plate (61) covering an opening of the case (59). In some embodiments, the case (59) and the cap plate (61) may be made of conductive materials. Here, a first terminal (62) and a second terminal (63) may be electrically connected to an internal positive electrode tab and a negative electrode tab, respectively, and may be installed to be exposed to the outside of the cap plate (61).

An electrolyte injection port (64) may be formed in the cap plate (61), and a gas discharge hole (65) may be opened, to which a vent, that is, a gas discharge device (66), may be coupled. The gas discharge device (66) may be opened by gas generated inside the battery to perform a degassing function.

FIG. 3B is a cross-sectional view taken along line I-I′ of FIG. 3A, illustrating the internal configuration of a prismatic secondary battery and the structure of the cap assembly (60).

The electrode assembly (40) may be formed by winding or stacking (laminating) a first electrode plate, a separator, and a second electrode plate, each of which is formed in a plate or sheet shape. When the electrode assembly (40) has a wound form (so-called jelly-roll), the winding axis may be parallel to the longitudinal direction of the case. In addition, the electrode assembly (40) may be of a stack type rather than a wound type. However, the shape of the electrode assembly (40) is not limited in the present disclosure. Further, the electrode assembly (40) may be a Z-stack electrode assembly in which a first electrode plate and a second electrode plate are inserted on both sides of a Z-folded separator. In addition, one or more electrode assemblies (40) may be stacked such that their long side surfaces are adjacent to each other and accommodated inside the case, and the number of electrode assemblies is not limited in the present disclosure. The first electrode plate of the electrode assembly (40) may serve as a negative electrode and the second electrode plate may serve as a positive electrode, or vice versa.

The first electrode plate is formed by applying a first electrode active material such as graphite or carbon onto a first electrode substrate formed of a metal foil such as copper, a copper alloy, nickel, or a nickel alloy, and may include a first electrode tab (or a first uncoated portion), which is a region where the first electrode active material is not applied. The first electrode tab (43) may serve as a current flow path between the first electrode plate and the first current collector plate (41). In some embodiments, the first electrode tab (43) may be formed by cutting the first electrode plate in advance so as to protrude from one side during manufacture of the first electrode plate, or may protrude further from one side than the separator without separate cutting.

The second electrode plate is formed by applying a second electrode active material such as a transition metal oxide onto a substrate formed of a metal foil such as aluminum or an aluminum alloy, and may include a second electrode tab (or a second uncoated portion) (44), which is a region where the second electrode active material is not applied. The second electrode tab (44) may serve as a current flow path between the second electrode plate and the second current collector plate (42). In some examples, the second electrode tab (44) may be formed by cutting the second electrode plate in advance so as to protrude from the other side during manufacture of the second electrode plate, or may protrude further from the other side than the separator without separate cutting.

Although the first electrode tab (43) and the second electrode tab (44) are illustrated as being positioned on the right side and the left side of the electrode assembly (40), respectively, in some embodiments, both the first electrode tab (43) and the second electrode tab (44) may be positioned together on either the right side or the left side of the electrode assembly (40). In addition, in embodiments, the first electrode tab (43) and the second electrode tab (44) may be positioned on an upper surface of the electrode assembly (40).

Here, the left side surface, right side surface, and upper surface of the electrode assembly (40) are defined for convenience of description with reference to the secondary batteries illustrated in FIGS. 2 and 3. The left side surface refers to a vertical surface of the electrode assembly (40) to which the second current collector plate (42) is joined, and the right side surface refers to the opposite surface to which the first current collector plate (41) is joined. The upper surface refers to a horizontal surface of the electrode assembly (40) facing the cap assembly (60) on which the first terminal (62) and the second terminal (63) are installed. Accordingly, the terms “left side surface,” “right side surface,” and “upper surface” of the electrode assembly (40) as used herein may be changed depending on left-right or up-down rotation of the secondary battery.

The separator functions to prevent a short circuit between the first electrode plate and the second electrode plate while allowing movement of lithium ions. The separator may be formed of, for example, a polyethylene film, a polypropylene film, or a polyethylene-polypropylene film.

In some embodiments, the electrode assembly (40) may be accommodated in the case (59) together with an electrolyte.

The first electrode tabs (43) and the second electrode tabs (44) protruding from the first electrode plate and the second electrode plate of the electrode assembly (40), respectively, may be connected to the first current collector plate (41) and the second current collector plate (42). When, as described herein, the first electrode tab (43) and the second electrode tab (44) are positioned on the upper surface of the electrode assembly (40), the first current collector plate and the second current collector plate may be positioned on the upper surface of the electrode assembly (40).

The first current collector plate (41) and the second current collector plate (42) are electrically connected to the first terminal (62) and the second terminal (63), respectively, through connection members (67). In some embodiments, an outer circumferential surface of the connection member (67) may be threaded and fastened to the first terminal (62) and the second terminal (63) by screw coupling. However, the present disclosure is not limited thereto, and the connection members (67) may be coupled to the first terminal (62) and the second terminal (63), respectively, by riveting or welding.

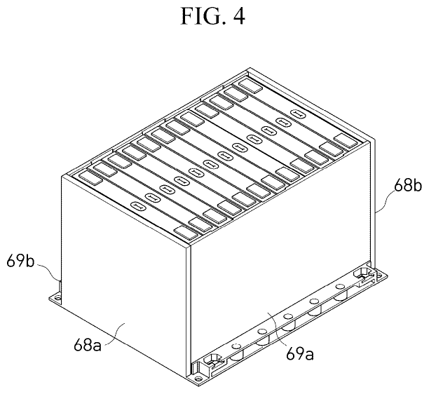

FIG. 4 is an illustration of a secondary battery module in which secondary batteries manufactured according to examples of the present disclosure are arranged. With the increase in secondary battery capacity for driving electric vehicles, and the like, a secondary battery module may be manufactured by arranging and connecting a plurality of secondary battery cells transversely and/or longitudinally. The plurality of secondary batteries may be arranged in a space defined by a pair of facing end plates 68a and 68b and a pair of facing side plates 69a and 69b. The secondary batteries may be designed appropriately in arrangement (direction) and number to obtain desired voltage and current specifications.

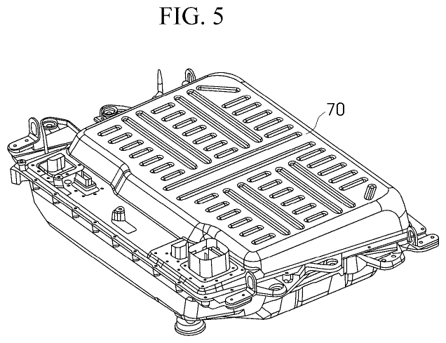

FIG. 5 is an illustration schematically showing the configuration of a battery pack 70 according to example embodiments of the present disclosure. Referring to FIG. 5, a battery pack 70 may include an assembly to which individual batteries are electrically connected, and a pack housing accommodating the same. In the drawings, for convenience of illustration, components including a bus bar, a cooling unit, external terminals for electrically connecting batteries, etc., are not shown.

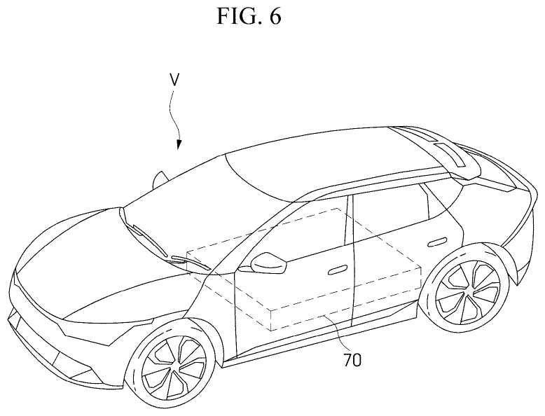

The battery pack 70 may be mounted on (or in) a vehicle. The vehicle may be, for example, an electric vehicle, a hybrid vehicle, a plug-in hybrid vehicle, and the like. The vehicle may be a four-wheeled vehicle or a two-wheeled vehicle but is not limited thereto. FIG. 6 shows a vehicle V which includes the battery pack 70 shown in FIG. 5 on the lower body thereof. The vehicle V may operate by (e.g., may be powered by) receiving power from the battery pack 70.

The secondary battery pack may include a battery and a battery management system (BMS: Battery Management System) for managing the battery. The BMS measures and monitors the voltage (V), current (I), temperature (T), and the like of a battery mounted in an electric vehicle, an energy storage system (ESS), or the like through sensors, and controls the battery so that it can exhibit optimal performance. The battery management system may include a detection device, a balancing device, and a control device.

The detection device may detect the state of the battery (V, I, T, etc.) and obtain state information representing the battery state. The detection device may detect the voltage of each cell or each secondary battery module constituting the battery. The detection device may detect the current flowing through each secondary battery module constituting the secondary battery module or the secondary battery pack. The detection device may detect the temperature of cells and/or modules and/or the ambient temperature at at least one point of the battery.

The balancing device may perform a balancing operation of the secondary battery modules and/or cells constituting the battery. The control device may receive state information (voltage, current, temperature, etc.) of the secondary battery modules from the detection device. The control device may monitor and calculate the state (voltage, current, temperature, state of charge (SOC), state of health (SOH), etc.) of the secondary battery modules based on the state information received from the detection device. In addition, the control device may perform control functions (for example, temperature control, balancing control, charge/discharge control, etc.) and protection functions (for example, prevention of over-discharge, overcharge, overcurrent, short circuit, fire suppression functions, etc.) based on the results of state monitoring. Further, the control device may perform wired or wireless communication functions with an external device of the secondary battery pack (for example, an upper-level controller, a vehicle, a charger, a PCS, etc.).

The control device may control charging and discharging operations and protection operations of the battery. For this purpose, the control device may include a charge/discharge control unit, a balancing control unit, and a protection unit.

The battery management system is a system that monitors the battery state and performs diagnostic, control, communication, and protection functions. The battery management system may calculate the charge/discharge state, calculate the battery life or state of health (SOH), cut off battery power when necessary (for example, relay control), perform thermal management (cooling, heating, etc.) control, perform a high-voltage interlock function, and detect or calculate insulation and short-circuit states.

The relay may be a mechanical contactor that is turned on and off by the magnetic force of a coil, or a semiconductor switch such as a MOSFET (Metal-Oxide-Semiconductor Field Effect Transistor).

The relay control may be configured to cut off power supply from the battery when a problem occurs in the vehicle or battery system, and may include one or more relays and a precharge relay disposed at each of, or at least one of, a positive terminal and a negative terminal.

Since there is a risk of generating an inrush current in a high-voltage capacitor on an inverter input side when a battery load is connected, the precharge control may include a function of operating the precharge relay before connecting a main relay during vehicle startup and connecting the precharge relay to a precharge resistor in order to prevent the inflow of inrush current.

The high-voltage interlock is a circuit that detects, using a small signal, whether all high-voltage components are connected in the entire vehicle system, and may include a function of forcibly opening a relay when an open condition occurs at any one point in the entire loop.

A battery according to embodiments of the present disclosure may be a secondary battery having various structures and forms, such as the pouch, cylindrical, and prismatic types, and may be formed at various locations, such as a cell case or a module case. That is, in the secondary battery, a space within a battery cell or a space within a module is extended when a temperature and/or pressure rises so that a temperature of the battery cell or module is lowered by adiabatic expansion. Accordingly, the extinguishment function operates automatically to prevent a fire.

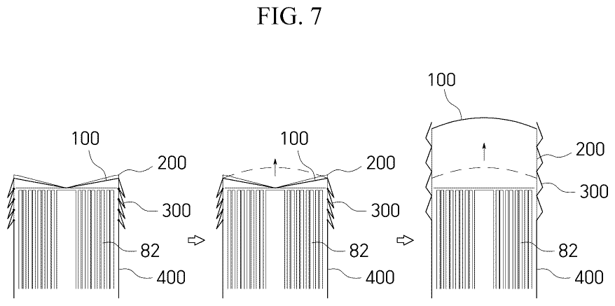

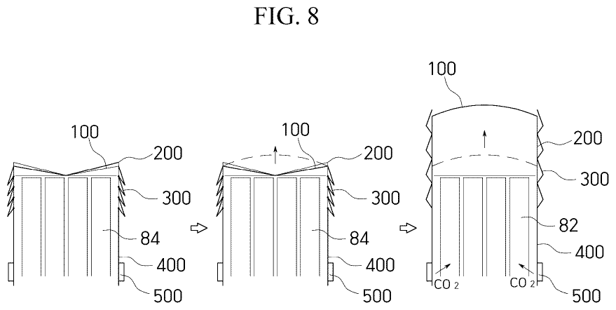

FIG. 7 is a schematic diagram illustrating an adiabatic expansion process of a battery cell case in a battery self-extinguishing device according to embodiments of the present disclosure. FIG. 8 is a schematic diagram illustrating an adiabatic expansion process of a battery module case in a battery self-extinguishing device according to embodiments of the present disclosure.

As illustrated, the battery self-extinguishing device according to embodiments of the present disclosure may include a plate 100 deformed when a temperature and/or pressure within a battery cell 82 rises, a moving tab 200 connected to the plate 100 and moved in response to the deformation of the plate 100, a side tab 300 including a wrinkle structure, connected to the moving tab 200, and having a wrinkle unfolded in response to a movement of the moving tab 200, and a case 400 connected to the side tab 300 and formed to have an internal space extended in response to the unfolding of the wrinkle of the side tab 300 so that a temperature of the battery cell 82 is lowered by adiabatic expansion.

The plate 100 according to embodiments of the present disclosure may have a structure in which the plate is deformed when a temperature and/or pressure within the battery cell 82 rises, and may be structurally deformed when overheating or a pressure change occurs within the battery cell 82.

The plate 100 may maintain a predetermined form in normal times, but may be deformed when a temperature within the battery cell 82 reaches a threshold or pressure within the battery cell 82 rises to a predetermined level or more.

The plate 100 according to embodiments of the present disclosure may have one area folded and may be unfolded upwardly when a temperature and/or pressure within the battery cell 82 rises. Furthermore, the plate 100 according to embodiments of the present disclosure may haves a downwardly convex dome shape, and may be deformed into an upwardly convex dome shape when pressure and/or a temperature within the battery cell 82 rises. This is for reducing pressure accumulated within the cell and securing an additional space therein.

When the battery cell 82 is overheated, an electrolyte within the battery cell 82 may be evaporated or gas may be generated within the battery cell 82. The plate 100 may be deformed upwardly or deformed from the downwardly convex dome shape to the upwardly convex dome shape so that an internal space within the battery cell 82 is extended and pressure within the battery cell 82 is reduced.

The unfolding and deformation of the dome shape of the plate 100 may induce adiabatic expansion so that heat within the battery is rapidly absorbed and an additional heat rise is suppressed. Accordingly, a risk of a fire and explosion which may occur in the battery cell 82 can be reduced.

In this case, the deformed plate 100 may be physically connected to the moving tab 200, thus moves the tab. The deformation of the plate 100 may function to detect a change in the state within the battery cell 82 in a mechanical way.

The moving tab 200 according to embodiments of the present disclosure may operate in response to the deformation of the plate 100. The moving tab 200 may be moved left and right or vertically in response to the deformation of the plate 100, and may induce the wrinkle structure of the side tab 300 to be deformed when the moving tab 200 is moved. Accordingly, pressure within the battery cell 82 can be reduced and the volume of the battery cell 82 can be extended.

The moving tab 200 according to embodiments of the present disclosure may be moved in response to the deformation of the plate 100, and may control the wrinkle of the side tab 300. Accordingly, a space within the battery cell 82 may be extended or contracted, and the moving tab 200 can perform a function for discharging heat or gas generated within the cell by adjusting pressure and a temperature within the battery.

That is, adiabatic expansion may be induced through the process, such as the deformation of the plate 100, a movement of the moving tab 200, control of the wrinkle of the side tab 300, and the extension of a space within the cell, thus preventing a battery fire or explosion by lowering a temperature within the battery.

The side tab 300 according to embodiments of the present disclosure may be designed to have the wrinkle structure, and has the wrinkle unfolded in response to a movement of the moving tab 200. When pressure or a temperature within the battery cell 82 rises, a space within the cell may be extended as the wrinkle of the side tab 300 is unfolded. Accordingly, a temperature of the battery cell 82 can be rapidly lowered by the occurrence of adiabatic expansion. As a result, a fire is prevented and the state within the battery cell 82 is rapidly stabilized.

The side tab 300 according to embodiments of the present disclosure may include the wrinkle structure. An internal space within the battery cell 82 can be extended as the wrinkle is unfolded upwardly and downwardly in response to a movement of the moving tab 200.

An internal space within the case 400 according to embodiments of the present disclosure may be extended as the wrinkle of the side tab 300 is unfolded. Such extension may function to lower a temperature within the cell by inducing adiabatic expansion. A temperature within the cell is rapidly lowered through the adiabatic expansion, thereby reducing a risk of a fire or explosion which may occur in the battery cell 82.

The case 400 according to embodiments of the present disclosure may include a carbon dioxide supply unit 500, and may supply carbon dioxide (CO2) to the inside of the battery cell 82.

CO₂ can suppress a fire by being supplied to the inside of the battery cell 82 when a fire occurs within the battery or a temperature within the battery rises. Such a structure can further reinforce the safety of the battery by operating as an additional extinguishing device in fire and overheating situations along with the adiabatic expansion.

That is, when CO₂ is supplied to the inside of the battery cell 82, a risk of a fire or explosion can be reduced because an oxygen concentration within the battery cell 82 is reduced. Furthermore, the safety of the battery can be further improved because heat is prevented from being accumulated within the battery cell 82 due to the supply of CO₂.

Furthermore, the carbon dioxide supply unit 500 can supply CO₂ to the inside of the battery cell 82 because carbon dioxide capsules operate when a temperature within the battery cell 82 exceeds a threshold.

The carbon dioxide capsules may be embedded in the carbon dioxide supply unit formed on one side of the case 400, and may be automatically supplied to the inside of the battery cell 82 when a temperature within the battery cell 82 exceeds a threshold.

CO₂ may be supplied along with the adiabatic expansion, and can thus lower a temperature within the battery cell 82. When CO₂ is supplied, a temperature and pressure within the battery cell 82 can be controlled. Accordingly, a battery system can be protected and the spreading of a fire can be suppressed because CO₂ rapidly operates right before a fire occurs or at the early stage of a fire.

As described herein, if the self-extinguishing device according to embodiments of the present disclosure is mounted on the battery cell 82 for an electric vehicle, when the battery cell 82 is overheated, a space within the cell may be extended due to the deformation of the plate 100 and through the interlocking of the moving tab 200 and the side tab 300. Accordingly, a temperature within the battery cell 82 can be lowered by adiabatic expansion, and the safety of the battery cell 82 can be secured even without an additional extinguishing device.

FIG. 7 is a schematic diagram illustrating an adiabatic expansion process of the battery cell case 400 in a battery self-extinguishing device according to embodiments of the present disclosure. When a temperature or pressure within the battery cell 82 rises, the moving tab 200 may be moved as the plate 100 is deformed so that the wrinkle of the side tab 300 is unfolded. Accordingly, the internal space of the cell case 400 may be extended, and a temperature within the battery in which adiabatic expansion is generated can be lowered.

Furthermore, the battery self-extinguishing device according to embodiments of the present disclosure may be formed at various locations, such as the cell case 400 or the module case 400. That is, a temperature of the battery cell 82 or a module can be lowered by adiabatic expansion because a space within the cell or a space within the module is extended when a temperature and/or pressure rises. Accordingly, the extinguishment function can automatically operate to prevent a fire.

FIG. 8 is a schematic diagram illustrating an adiabatic expansion process of a battery module case 400 in a battery self-extinguishing device according to embodiments of the present disclosure.

The battery self-extinguishing device according to embodiments of the present disclosure may include a plate 100 deformed when a temperature and/or pressure within a battery module 84 rises, a moving tab 200 connected to the plate 100 and moved in response to the deformation of the plate 100, a side tab 300 connected to the moving tab 200 and having a wrinkle structure and having a wrinkle unfolded in response to a movement of the moving tab 200, a case 400 connected to the side tab 300 and formed to have an internal space extended in response to the unfolding of the wrinkle of the side tab 300 so that a temperature of the battery module 84 is lowered by adiabatic expansion, and a carbon dioxide supply unit 500 that supplies CO₂ to the inside of the battery module 84.

That is, when pressure or a temperature within the battery module 84 exceeds a predetermined threshold, the plate 100 may be deformed, which moves the moving tab 200. Accordingly, the moving tab 200 is connected to the side tab 300 and can control the wrinkle structure of the side tab 300. The movement of the moving tab 200 can extend a space within the battery module 84 through the side tab 300 so that heat and pressure can be distributed.

The side tab 300 has the wrinkle structure, and can adjust a space within the battery module 84 in a way that the wrinkle of the side tab 300 is unfolded or folded as the moving tab 200 is moved. That is, when the wrinkle is unfolded, the space within the battery module 84 can be extended. Accordingly, a temperature within the battery module 84 can be suddenly lowered because adiabatic expansion occurs in this process.

The adiabatic expansion can rapidly solve overheating occurring within the battery module 84, thereby guaranteeing the safety of a battery.

The carbon dioxide supply unit 500 may function to block the supply of oxygen and the occurrence of a fire by supplying CO₂ to the inside of the battery module 84. CO₂ can lower a temperature of a battery and prevent a fire by preventing combustion within the battery and suppressing a chemical reaction which may occur within the battery module 84.

The case 400 may extend a space within the battery module 84 as the wrinkle structure is unfolded and lowers a temperature within the battery module 84 through adiabatic expansion.

For example, when a temperature within the battery module 84 for an electric vehicle suddenly rises or pressure within the battery 84 for an electric vehicle exceeds a threshold, the plate 100 may be deformed and thus the moving tab 200 can operate. The moving tab 200 may control the wrinkle of the side tab 300 so that a space within the battery module 84 is extended. Accordingly, a temperature within the battery module 84 can be lowered, and overheating or explosion can be prevented because adiabatic expansion occurs in this process.

Furthermore, the carbon dioxide supply unit 500 may operate to supply CO₂ to the inside of the battery module 84. Accordingly, combustion can be blocked, and a fire within a battery can be extinguished or prevented.

FIG. 8 is a schematic diagram illustrating an adiabatic expansion process of the battery module case 400 in a battery self-extinguishing device according to embodiments of the present disclosure, and illustrates a form in which the battery module case 400 is extended. In this case, the side tab 300 may be extended to extend the internal volume of the entire module.

The battery self-extinguishing device according to embodiments of the present disclosure may include a dome-shaped plate 100 that blocks an electrical connection with an electrode tab 86 by being deformed when a temperature and/or pressure within a battery cell 82 rises, a moving tab 200 connected to the dome-shaped plate 100 and configured to move in response to the deformation of the dome-shaped plate 100, a side tab 300 connected to the moving tab 200 and having a wrinkle structure and having a wrinkle unfolded in response to a movement of the moving tab 200, and a case 400 connected to the side tab 300 and formed to have an internal space extended in response to the unfolding of the wrinkle of the side tab 300 so that a temperature of the battery cell 82 is lowered by adiabatic expansion.

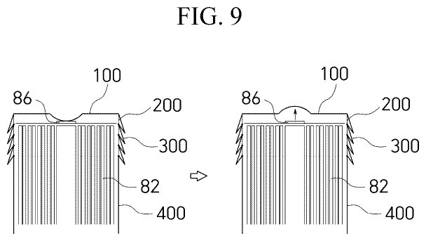

FIG. 9 illustrates a process of the dome-shaped plate 100 being deformed in a battery self-extinguishing device according to embodiments of the present disclosure, and illustrates the dome-shaped plate 100.

The present embodiment relates to a battery self-extinguishing device including the dome-shaped plate 100 that operates when pressure or a temperature within the battery cell 82 rises. The dome-shaped plate 100 may have a function for blocking an electrical connection with the electrode tab 86. The moving tab 200 and the side tab 300 may operate in conjunction with each other to extend a space within the battery cell 82 and to lower a temperature within the battery cell 82 through adiabatic expansion in response to the deformation of the dome-shaped plate 100.

The dome-shaped plate 100 may be deformed when pressure and a temperature within the battery cell 82 rises. In this case, the dome-shaped plate 100 can prevent an electrical short circuit or electrical heating which may occur within a battery by blocking an electrical connection with the electrode tab 86.

In this case, the blocking of the electrode tab 86 may be an important step of preventing a fire of the battery cell 82. The stability of the battery can be improved by blocking the electrical connection. In this case, the dome-shaped plate 100 can minimize an electrical reaction attributable to overheating within the battery cell 82.

The deformation of the dome-shaped plate 100 may move the moving tab 200. The moving tab 200 is connected to the side tab 300 and can control the wrinkle structure of the side tab 300. Accordingly, a space within the battery cell 82 may be extended through a process of the wrinkle of the side tab 300 being unfolding or folded in response to a movement of the moving tab 200.

When the wrinkle of the side tab 300 is unfolded, adiabatic expansion may occur within the battery cell 82. Such a process can suddenly lower a temperature within the battery cell 82, and can solve an overheating situation which may occur within the battery cell.

For example, when a temperature within the battery cell 82 for an electric vehicle suddenly rises or pressure within the battery cell 82 rises, the dome-shaped plate 100 may be deformed to block an electrical connection with the electrode tab 86. Accordingly, electrical heating or a short circuit which may occur within the battery cell 82 can be prevented. Furthermore, when the dome-shaped plate 100 is deformed, the moving tab 200 may be moved and unfold the wrinkle of the side tab 300 so that a space within the battery cell 82 is extended to induce adiabatic expansion. Accordingly, a fire or explosion within the battery cell 82 can be prevented because a temperature within the battery cell 82 is suddenly lowered.

FIG. 9 illustrates a process of the plate 100 being deformed in a battery self-extinguishing device according to embodiments of the present disclosure. The dome-shaped plate 100 may be deformed from a downwardly convex form to an upwardly convex form when pressure within the battery cell 82 rises and extends an internal volume. Accordingly, the dome-shaped plate 100 can prevent electrical heating or a short circuit by blocking an electrical connection with the electrode tab.

As a result, the dome-shaped plate 100 can block an electrical connection with the electrode tab in response to an increase in the temperature and pressure within the battery cell 82, and may function to control a temperature of the battery cell 82 by extending a space within the battery cell 82 through the moving tab 200 and the side tab 300.

According to embodiments of the present disclosure, it is possible to prevent a fire and maintain the stability of a battery by automatically responding to an increase in the temperature and pressure within the battery cell or module. A space within the battery cell is extended through the interlocking action of the plate, the moving tab, and the side tab. The possibility of a fire can be reduced because a temperature within the battery cell or module is lowered.

According to embodiments of the present disclosure, the battery self-extinguishing device detects a change within the battery cell or module and automatically operates even without the supply £ of external power, resulting in a cost reduction and ease of installation.

According to embodiments of the present disclosure, as the wrinkle structure of the side tab is unfolded, adiabatic expansion occurs. Accordingly, a fire within a battery is prevented because a temperature within the battery cell or module is lowered.

Hereinafter, any material that may be usable for the secondary battery according to examples of the present disclosure will be described.

As the positive electrode active material, a compound capable of reversibly intercalating/deintercalating lithium (e.g., a lithiated intercalation compound) may be used. For example, at least one of a composite oxide of lithium and a metal such as at least one of cobalt, manganese, nickel, and combinations thereof may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by at least any one of the following formulas may be used: LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-αDα (0.90<a≤1.8, 0<b>0.5, 0≤c≤0.5, 0<α<2); LiaNi1-b-cMnbXcO2-αDα (0.90≤a≤1.8, 0≤b≤0.5, 0≤c≤0.5, 0<α<2); LiaNibCocLldGeO2 (0.90≈a≤1.8, 0≈b≈0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f)Fe2(PO4)3 (0≤f≤2); and LiaFePO4 (0.90≤a≤1.8).

In the herein formulas: A is or includes at least Ni, Co, Mn, or a combination thereof; X is or includes at least Al, Ni, Co, Mn, Cr, Fe, Mg, Sr, V, a rare earth element, or a combination thereof; D is or includes at least O, F, S, P, or a combination thereof; G is or includes at least Al, Cr, Mn, Fe, Mg, La, Ce, Sr, V, or a combination thereof; and L1 is or includes at least Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 w t% on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be or include aluminum (Al) but is not limited thereto.

The negative electrode active material may include a material capable of reversibly intercalating/deintercalating at least one of lithium ions, lithium metal, an alloy of lithium metal, a material capable of being doped and undoped with lithium, or a transition metal oxide.

The material capable of reversibly intercalating/deintercalating lithium ions may be or include a carbon-based negative electrode active material, which may include, for example, at least crystalline carbon, amorphous carbon, or a combination thereof. Examples of the crystalline carbon may include graphite, such as natural graphite or artificial graphite, and examples of the amorphous carbon may include at least one of soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be or include at least silicon, a silicon-carbon composite, SiOx (0<x<2), a Si-based alloy, or a combination thereof.

The silicon-carbon composite may be or include a composite of silicon and amorphous carbon. According to one example embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For Example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, at least one of copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent may constitute a medium through which ions involved in the electrochemical reaction of the battery can move.

The non-aqueous organic solvent may be or include at least a carbonate-based, an ester-based, an ether-based, a ketone-based, an alcohol-based solvent, an aprotic solvent, and may be used alone or in combination of two or more.

Depending on the type of lithium secondary battery, a separator may be present between the first electrode plate (e.g., the negative electrode) and the second electrode plate (e.g., the positive electrode). As the separator, at least polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth) acrylic polymer.

The Inorganic Material May Include Inorganic particles such as at least one of Al2O3, SiO2, TiO2, SnO2, CeO2, MgO, NiO, CaO, GaO, Zno, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

Although the present disclosure has been described herein with reference to limited embodiments and drawings, the present disclosure is not limited thereto, and it will be apparent that various modifications and variations may be made by a person having ordinary skill in the art to which the present disclosure pertains, within the technical spirit of the present disclosure and the scope of equivalents of the claims set forth herein.

What is claimed is:

1. A battery self-extinguishing device, comprising:
a plate deformed when pressure and/or a temperature within a battery cell rises;
a moving tab connected to the plate and moved in response to the deformation of the plate;
a side tab connected to the moving tab and having a wrinkle structure and having a wrinkle unfolded in response to the movement of the moving tab; and
a case connected to the side tab and formed to have an internal space extended as the wrinkle of the side tab is unfolded so that a temperature of the battery cell is lowered by adiabatic expansion.

2. The battery self-extinguishing device as claimed in claim 1, wherein one area of the plate is folded and then unfolded upwardly when pressure and/or a temperature within the battery cell rises.

3. The battery self-extinguishing device as claimed in claim 1, wherein the plate is formed in a downwardly convex dome shape, and the downwardly convex dome shape of the plate is deformed in an upwardly convex dome shape when pressure and/or a temperature within the battery cell rises.

4. The battery self-extinguishing device as claimed in claim 1, wherein the moving tab is moved in response to the deformation of the plate and controls the wrinkle of the side tab.

5. The battery self-extinguishing device as claimed in claim 1, wherein the side tab has the wrinkle structure and extends the internal space as the wrinkle is unfolded upwardly and downwardly in response to the movement of the moving tab.

6. The battery self-extinguishing device as claimed in claim 1, wherein a carbon dioxide supply unit is formed in the case and supplies carbon dioxide to an inside of the battery cell.

7. The battery self-extinguishing device as claimed in claim 6, wherein carbon dioxide capsules in the carbon dioxide supply unit supplies the carbon dioxide to the inside of the battery cell by operating when a temperature within the battery cell exceeds a threshold.

8. A battery self-extinguishing device comprising:
a substantially dome-shaped plate configured to block an electrical connection with an electrode tab by being deformed when pressure and/or a temperature within a battery cell rises;
a moving tab connected to the substantially dome-shaped plate and moved in response to the deformation of the substantially dome-shaped plate;
a side tab connected to the moving tab and having a wrinkle structure and having a wrinkle unfolded in response to the movement of the moving tab; and
a case connected to the side tab and formed to have an internal space extended in response to the unfolding of the wrinkle of the side tab so that a temperature of the battery cell is lowered by adiabatic expansion.

9. The battery self-extinguishing device as claimed in claim 8, wherein the moving tab is moved in response to the deformation of the plate and controls the wrinkle of the side tab.

10. The battery self-extinguishing device as claimed in claim 8, wherein the side tab has the wrinkle structure and extends the internal space as the wrinkle is unfolded upwardly and downwardly in response to the movement of the moving tab.

11. The battery self-extinguishing device as claimed in claim 8, wherein a carbon dioxide supply unit is formed in the case and supplies carbon dioxide to an inside of the battery cell.

12. The battery self-extinguishing device as claimed in claim 11, wherein carbon dioxide capsules in the carbon dioxide supply unit supplies the carbon dioxide to the inside of the battery cell by operating when a temperature within the battery cell exceeds a threshold.

13. A battery module self-extinguishing device comprising:
a plate deformed when a temperature and/or pressure within a battery module rises;
a moving tab connected to the plate and moved in response to the deformation of the plate;
a side tab connected to the moving tab and unfolded in response to the movement of the moving tab;
a case connected to the side tab and having an internal space extended in response to the unfolding of the wrinkle of the side tab so that a temperature of the battery module is lowered by adiabatic expansion; and
a carbon dioxide supply unit configured to supply carbon dioxide to an inside of the battery module.

14. The battery module self-extinguishing device as claimed in claim 13, wherein one area of the plate is folded and then unfolded upwardly when pressure and/or a temperature within the battery cell rises.

15. The battery module self-extinguishing device as claimed in claim 13, wherein the plate is formed in a downwardly convex dome shape, and the downwardly convex dome shape of the plate is deformed in an upwardly convex dome shape when pressure and/or a temperature within the battery cell rises.

16. The battery module self-extinguishing device as claimed in claim 13, wherein the moving tab is moved in response to the deformation of the plate and controls the wrinkle of the side tab.

17. The battery module self-extinguishing device as claimed in claim 13, wherein the side tab has the wrinkle structure and extends the internal space as the wrinkle is unfolded upwardly and downwardly in response to the movement of the moving tab.

18. The battery module self-extinguishing device as claimed in claim 13, wherein carbon dioxide capsules in the carbon dioxide supply unit supplies the carbon dioxide to the inside of the battery cell by operating when a temperature within the battery cell exceeds a threshold.
